(19) United States
(12) Patent Application Publication
(10) Pub. No.: US 2010/0260500 A1
(43) Pub. Date: Oct. 14, 2010

(54) MULT9-DEGREE WAVELENGTH CROSS-CONNECT USING BIDIRECTIONAL WAVELENGTH SELECTIVE SWITCH

(75) Inventors: Philip Nan JI, PRINCETON, NJ (US); Ting WANG, PRINCETON, NJ (US); Yoshiaki AONO, TOKYO (JP)

Correspondence Address: BROSEMER, KOLEFAS & ASSOCIATES, LLC (NECL), ONE BETHANY ROAD BUILDING 4 - SUITE #58, HAZLET, NJ, 07730, US

(73) Assignee: NEC LABORATORIES AMERICA INC, PRINCETON, NJ (US)

(21) Appl. No.: 12/712,701

(22) Filed: Feb. 25, 2010

Related U.S. Application Data
(60) Provisional application No. 61/167,601, filed on Apr. 8, 2009.

(51) Int. Cl. H04J 14/02

(52) U.S. Cl. 398/50

(57) ABSTRACT

A modular wavelength cross connect node for use in a dense wavelength division multiplexing network exhibiting low cost and improved performance by employing a bidirectional wavelength selective switch in a main optical path and using optical circulators to share any common ports.

### CROSS REFERENCE TO RELATED APPLICATION

This application claims the benefit of U.S. Provisional Patent application Ser. No. 61/167,601 filed Apr. 8, 2009 which is incorporated by reference as if set forth at length herein.

### FIELD OF DISCLOSURE

This disclosure relates to the field of telecommunications and in particular to a multi-degree wavelength cross-connect employing a bidirectional wavelength selective switch.

### BACKGROUND OF DISCLOSURE

As the volume of global communications traffic increases there is an increasing set of demands being placed on backbone optical networks and in particular those optical networks which employ dense-wavelength-division-multiplexing (DWDM). A critical component of existing networks, DWDM optical switching nodes must rapidly evolve to meet these demands.

### SUMMARY OF DISCLOSURE

An advance is made in the art according to an aspect of the present invention directed to a multi-degree wavelength cross connect optical node offering improved cost and performance characteristics.

According to an aspect of the present disclosure the multi-degree wavelength cross connect optical node is constructed using a bidirectional wavelength selective switch (WSS) and circulators to achieve functional equivalence of two WSS (one at the input and the other at the output) while only requiring a single WSS device.

With such an exemplary WXC node architecture, a signal at an Input and a Drop end travels in the same WSS as an Add and an Output end, but in opposite direction. Circulators are placed at each fiber port to control and separate the ingress and egress light travelling directions.

Its modular architecture allows easy node configuration and “add-as-you-grow” implementation strategy while exhibiting a lower optical loss and avoiding wavelength contention problems associated with the prior art. As compared with prior art configurations employing two WSS per module, the cost of a module constructed according to the present disclosure is lower, along with the hardware footprint.

### BRIEF DESCRIPTION OF THE DRAWING

A more complete understanding of the disclosure may be realized by reference to the accompanying drawing in which:

FIG. 1 is a schematic of a basic configuration for a bidirectional wavelength selective switch based multi-degree wavelength cross connect node sub module according to an aspect of the present disclosure;

FIG. 2 is a schematic of a drop priority configuration for a bidirectional wavelength selective switch based multi-degree wavelength cross connect node sub module according to an aspect of the present disclosure;

FIG. 3 illustrates the basic configuration of FIG. 1 with additional optical amplifiers according to an aspect of the present disclosure;

FIG. 4 illustrates the basic configuration of FIG. 1 including optical monitoring according to an aspect of the present disclosure;

FIG. 5 is a schematic of a wavelength cross connect sub-module according to an aspect of the present disclosure; and

FIG. 6 is a schematic of a multi-degree wavelength cross connect formed by multiple wavelength cross connect sub-modules according to an aspect of the present disclosure.

### DESCRIPTION OF EMBODIMENTS

The following merely illustrates the principles of the various embodiments. It will thus be appreciated that those skilled in the art will be able to devise various arrangements which, although not explicitly described or shown herein, embody the principles of the embodiments and are included within their spirit and scope.

Furthermore, all examples and conditional language recited herein are principally intended expressly to be only for pedagogical purposes to aid the reader in understanding the principles of the embodiments and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

The functions of the various elements shown in the FIGs., including functional blocks labeled as “processors” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Similarly, any switches shown in the FIGs. are conceptual only. Their function may be carried out through the operation of program logic, through dedicated logic, through the interaction of program control and dedicated logic, or even manually, the particular technique being selectable by the implementor as more specifically understood from the context.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicants thus regard any means which can provide those functionalities as equivalent as those shown herein.

Unless otherwise explicitly specified herein, the drawings are not drawn to scale.

By way of some additional background, it is noted that in order to construct a multi-degree WXC node, one way is to employ an array of large scale optical switch matrices and use an array of demultiplexers at the node's inputs and an array of multiplexers at the node's outputs. As may be readily appreciated by those skilled in the art, this is a costly solution, especially when the number of wavelengths and port counts are large. It also requires large hardware footprint.

Now, with the widespread availability and relative maturity of wavelength-selective switch (WSS) technology, multi-degree WXC can be constructed using a WSS device which offers high level of integration. One relatively straightforward, prior-art implementation of an WXC using WSSs places a 1×K WSS at each input end, and a K×1 WSS at each output end of the switch. The disperse ports (as opposing to the Common Port) of the WSS are divided to perform signal passing-through (or called Express), local add/drop, or cross-connect respectively. The cross-connect is performed by interconnecting these ports among the WSS units. Demultiplexers and multiplexers are placed at the Drop and Add ports for local add/drop. And while such an implementation is somewhat flexible, it is also quite costly as it requires 2×N WSS units to implement an N×N WXC node.

Fortunately, the hardware cost for such an implementation may be reduced by almost half by replacing the WSS at either the input end or the output end with a passive multi-port coupler or splitter. However the inclusion of the multi-port coupler/splitter leads to larger insertion loss and there may also be a wavelength contention issue, as signals with the same wavelength (channel) from different inputs can arrive at the same output port and interfere with one another.

With these prior art deficiencies in mind a WXC node constructed according to the present disclosure exhibits a modular architecture. Such a node includes N sets of sub-modules, each having a bidirectional WSS and several circulators to connect input and output ports.

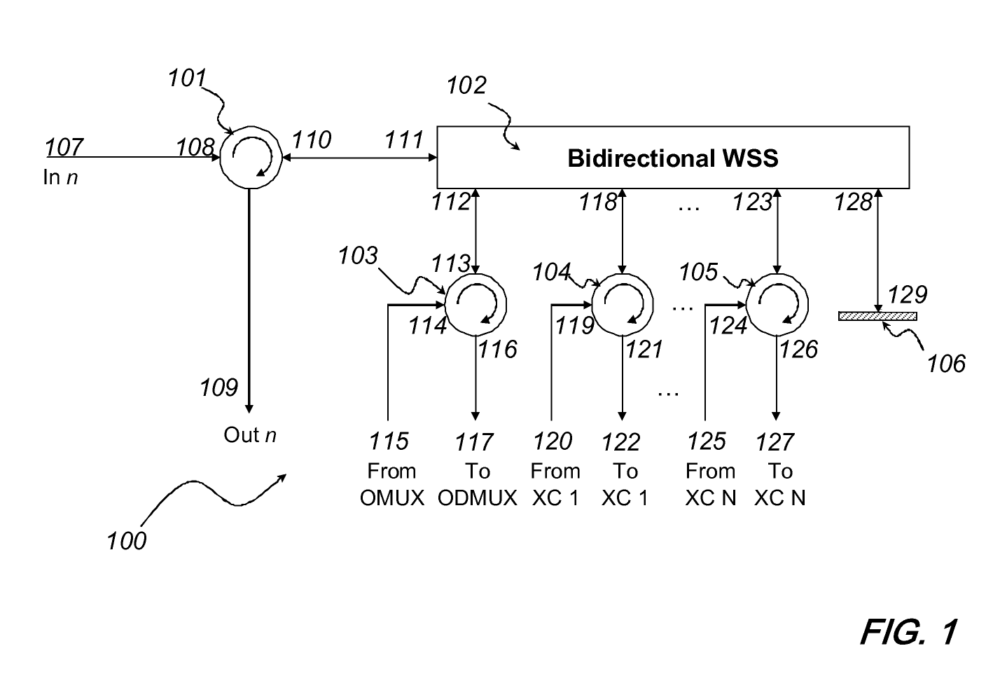

Turning now to FIG. 1, there is shown a basic configuration of a WXC node constructed according to the teachings of the present disclosure. As shown there, input DWDM signals 107 are directed to a Common port 111 of a WSS 102 through the effect of an optical circulator 101. Those skilled in the art will readily appreciate that such a circulator may advantageously be a Faraday rotator-based 3 port passive optical device that enables light to travel uni-directionally from Port 1 108 to Port 2 110, and from Port 2 110 to Port 3 109, but not in reverse.

Within the WSS 102, the input signals are separated into different WSS output ports according to their target destination, namely a Through path 128, a Drop path 112 and Cross-connect paths (118 and 123). The signals directed to the Through path are reflected back to the WSS by—for example—a passive reflective device 106 such as a fiber mirror reflector or a Faraday mirror. The reflected signals travel a reverse direction in the WSS 102 to the circulator via the Common port of the WSS 111. There these reflected Through signals exit the WXC node via the third port 109 of the circulator 101.

It is noted at this point that the Through path—as that term is used herein is sometimes referred to in the art as a “LoopBack” port.

The Drop path 112 signals are sent to another circulator 103 at the corresponding WSS output port, and then to the optical demultiplexer 117.

Multiplexed Add channels 115 from optical multiplexer are sent to the WSS after being received at another port 114 of the circulator 103 and travel in a reverse direction in the WSS 102, and subsequently exit the node via input circulator 101.

Cross-connect channels (118 and 123) for respective Cross-connect paths travel similarly to the Drop and Add signals, and they are interconnected with other sub-modules via “From XC” ports (120, 125) and “To XC” ports (122, 127) via respective circulators (104, 105).

For a single 1×M bidirectional WSS constructed according to the principles of the present disclosure, the number of Cross-connect paths available is M−2, and the number of circulators required is M. In other words, 9 circulators, 1 mirror reflector and a 1×9 bi-directional WSS may be used to construct a WXC sub-module having Through, Add, Drop and 7 Cross-connect paths. As may be readily appreciated, such functionality is sufficient for an 8-degree WXC node with local Add/Drop.

As may be further appreciated, with this design, each sub-module only requires 1 WSS unit, but achieves the level of functionality as a node having WSS units at both the ingress end and the egress end. Accordingly, as comparing with existing designs exhibiting similar functionality, a node so constructed according to the teachings of the present disclosure advantageously reduces the hardware cost almost by half (since the WSS is the most costly component), and furthermore reduces WXC node footprint and power consumption. Additionally, and as compared to other designs that use one WSS and one multi-port coupler, such a node according to the present disclosure improves the optical performance (such as lower optical insertion loss) and avoids wavelength contention issue by having the WSS functions at both ends.

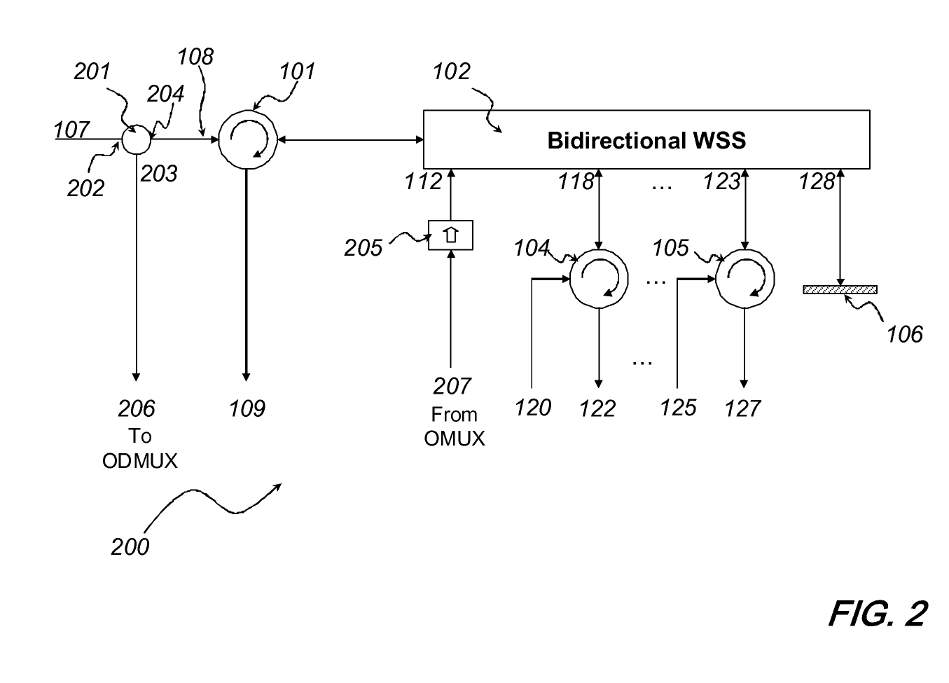

Turning now to FIG. 2 there is shown a modified sub-module configuration according to an aspect of the present disclosure which advantageously gives a higher priority to signals that are dropped locally. As may be appreciated, such a module may be used in systems where a Drop path has a strict optical loss budget.

In the configuration shown in FIG. 2, a 1×2 splitter 201 is positioned at the input end before the common port circulator 101 to form a Broadcast-and-Select architecture. All input channels are directed to a Drop path 206 (with half of the power or different percentage depending on the splitting ratio on the splitter), and also to Through and Cross-connect paths (with the remaining power) via WSS 102.

Because of this Broadcast-and-Select architecture, input signals may exhibit multicasting functions. For example, signals travelling via Through path 128 may exhibit a “Drop-and-Continue” characteristic wherein that they are dropped at 206 and also sent to the sub-module output 109. Any signals travelling via Cross-connect paths (e.g., 118 or 123) may exhibit a “Drop-and-Cross” characteristic, wherein they are dropped at 206 and also sent to other sub-modules via “To XC” ports (e.g., 122 and 127).

Signals may be dropped again locally as shown as 117 in FIG. 1. In such a situation, they must have the same channel listing as the added channels (e.g., 115 in FIG. 1). However, this “drop twice” is not commonly required. More practically, the circulator (103 in FIG. 1) at Add/Drop port of the WSS may be replaced with an isolator 205 to slightly reduce the hardware cost and insertion loss.

As may now be readily appreciated, different elements may be added to these sub-module configurations. Some are specific to the bi-directional WSS-based architecture, while others may be applied to other WXC configurations.

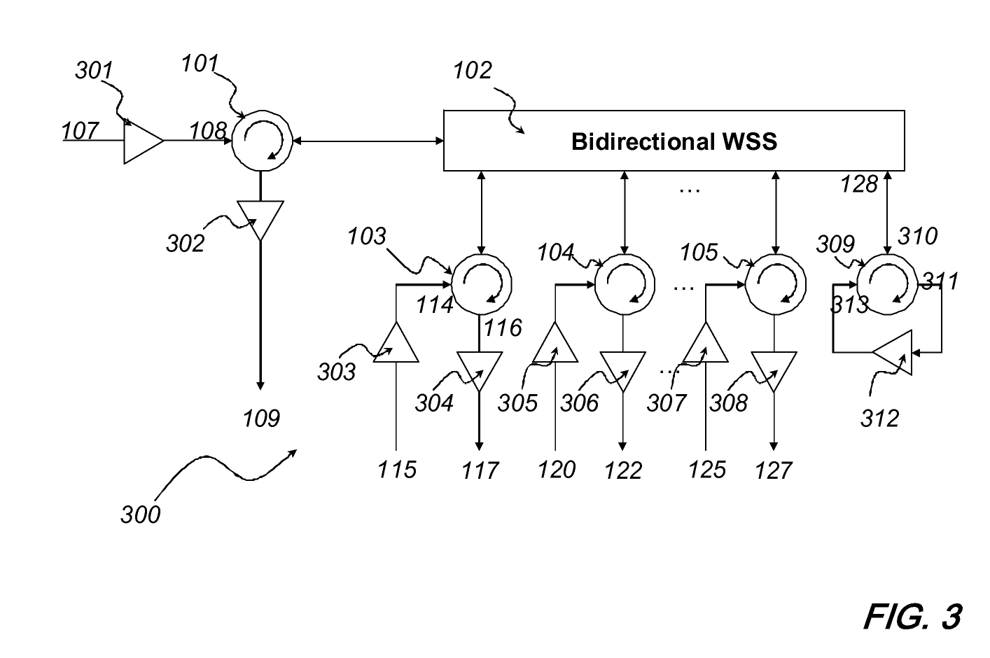

More particularly, optical amplifiers may be placed at various locations within the sub-module. Turning now to FIG. 3, two common amplifiers are located at the input side of the module namely, a receiving amplifier RXAMP, 301 and at the output end of the module a transmission amplifier TXAMP, 302. The RXAMP amplifies DWDM signals entering into the WXC node, while the TXAMP amplifies the outgoing DWDM signals (including the Through/express channels, locally added channels, and Cross-connect channels from other sub-modules) before they exit they WXC node. Amplifiers can also be placed at other ingress or egress ports such as the Drop port, Add port, and Cross-connect ports 303-308. The Through channel signals can also be amplified by replacing the reflecting device (106 in FIG. 1 with another 3-port circulator 309 and repositioning amplifier 312 between the two circulator ports (311 and 313).

In the WXC node, the DWDM signals can be equalized using the WSS per-channel attenuation function. For cross-connect paths, proper inter-channel equalization can be done by concurrently controlling the amplification and per-channel attenuation.

Additionally, optical signal monitoring may be included with this WXC node. More particularly, optical monitoring may be performed on a per-fiber or per-channel monitoring basis—although per-channel monitoring is generally more useful in a DWDM system—and the parameters monitored may include—for example—optical power (most common), optical signal-to-noise ratio, chromatic dispersion, polarization mode dispersion, etc. As may be appreciated, with a configuration according to an aspect of the present disclosure optical signal monitoring may be advantageously achieved by placing a tap splitter at the measurement point to extract a small portion of the optical signal and then process the tapped signal to obtain the target information.

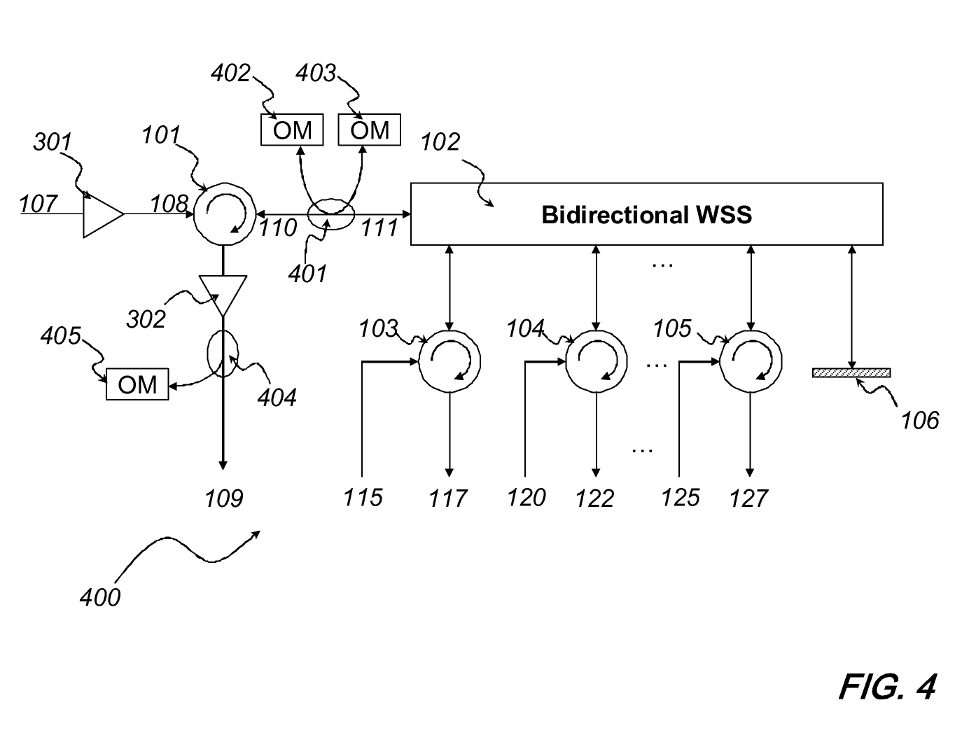

Useful places to position optical monitoring are—for example—at the input after the receiving amplifier RXAMP 301 (this is also the input of the WSS), the output of the WSS 102, and the output of the transmission amplifier TXAMP 302—as shown in FIG. 4. With this bidirectional WXC architecture shown in FIG. 4, the monitoring at the RXAMP output and the WSS output can share a common splitter 401. Instead of using two 1×2 splitters, a single 2×2 splitter is used. Thus the optical insertion loss due to the tap splitter is reduced by half, and the splitter cost is also reduced—while other hardware and related costs remain unchanged. The outputs of the 2×2 splitter are detected by optical monitoring elements 402 and 403 (for WSS output and RXAMP output monitoring respectively). The TXAMP output is tapped out by a 1×2 splitter 404 and detected at optical monitoring element 405.

In addition to optical monitoring, optical regeneration elements can also be placed within the WXC node, as well as optical-electrical-optical (OEO) elements, to achieve functions such as optical signal regeneration, sub-wavelength grooming and wavelength conversion.

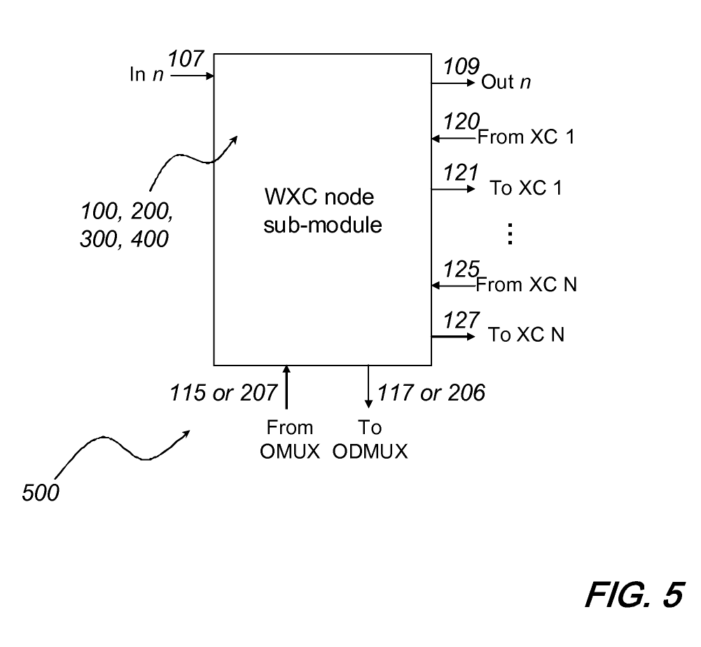

With this discussion of sub-module design and variations thereof in place, we may now describe an entire WXC node. Turning now to FIG. 5, there is shown such a modular WXC node according to an aspect of the present disclosure. In this exemplary embodiment shown, it has a modular architecture and the N×N WXC node is constructed by N sets of sub-modules.

To further illustrate such construction of the WXC node using the sub-modules, we use a common model in FIG. 5 to illustrate construction. Importantly, regardless of which specific design configuration(s) are employed, i.e., basic design, Drop-Priority design, etc, and regardless of which options are included, i.e., some or all amplifiers, various monitoring elements, optical regeneration, grooming, wavelength conversion, or combinations thereof, the sub-module can be represented as a subsystem having a single input port 107, a single output port 109, a single Drop port 117 or 206, that is connected to optical an demultiplexing element (if only 1 channel is drop, it can be directly connected to the input of a transponder), a single Add port 115 or 207 that is connected to optical multiplexing or coupling element (if only 1 channel is added, it can be directly connect to the output of a transponder), multiple sets of Cross-connect ports 120, 121, 125, 127 to and from other sub-modules. Such a broad module is represented as element 500 in FIG. 5.

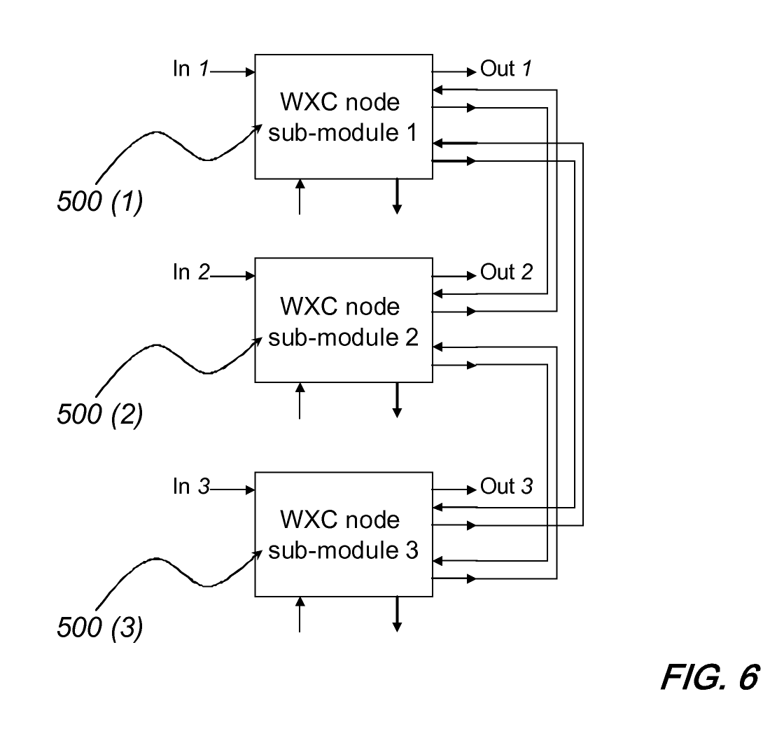

Turning now to FIG. 6, there is illustrated a schematic of a 3×3 WXC node comprising 3 sub-modules according to a further aspect of the present disclosure. More specifically, three separate sub-modules (500(1), 500(2), and 500(3)), are shown receiving a separate input each. Benefits flowing from such a modular architecture include, for example WXC nodes having different degrees to be custom constructed (the degree of the node is up to a certain limit), such as 4×4 or 5×5 or 8×8. Thus it offers the flexibility in node configuration, and it offers “build-as-you-grow” deployment strategy and reduces the initial hardware cost.

At this point, while we have discussed and described the invention using some specific examples, those skilled in the art will recognize that our teachings are not so limited. Accordingly, the invention should be only limited by the scope of the claims attached hereto.

1. A multi-degree wavelength cross connect (WXC) module comprising:
a bidirectional wavelength selective switch (WSS) having a plurality of input/output ports wherein one of the ports (THROUGH) is in optical communication with a reflective structure and the remainder of the ports are in optical communication with a plurality individual optical circulators, one for each of the remaining ports respectively.

2. The module of claim 1 wherein said WSS comprises:
a common input/output port wherein its respective optical circulator includes a module input port and a module output port;
one or more add/drop ports; and
one or more cross-connect ports;
wherein any dense wavelength division multiplexed optical signals received at the module input port are directed into the WSS common port via its respective optical circulator; and
through channels are selected and directed back through the WSS through the effect of the reflective structure and subsequently exit the module output port; and
dropped channels are selected by the WSS and sent to the drop port via another circulator.

3. The module of claim 2 further comprising an optical splitter positioned in the optical path of module input port prior to the optical circulator such that optical signals received at the splitter are dropped locally and simultaneously sent to the WSS simultaneously.

4. The module of claim 3 wherein the ADD/DROP port circulator is replaced by an isolator.

5. The module of claim 2 further comprising one or more optical amplifiers positioned in the optical path of one or more of the following ports including the Add/Drop port, the Common port, and the Cross-connect port.

6. The module of claim 1 wherein the reflective structure is replaced by a circulator and optical amplifier.
